(19) United States
(12) Patent Application Publication
(10) Pub. No.: US 2022/0084744 A1
(43) Pub. Date: Mar. 17, 2022

(54) INFINITY COIL FOR WIRELESS CHARGING

(71) Applicants: Hyundai Motor Company, Seoul (KR); Kia Motors Corporation, Seoul (KR)

(72) Inventors: Joseph Steffey, Brownstown Township, MI (US); Bilal Javaid, Ada, MI (US)

(21) Appl. No.: 17/022,912

(22) Filed: Sep. 16, 2020

(51) Int. Cl. H01F 38/14; H02J 7/02; H02J 50/40; H02J 50/10; H02J 7/00; H02J 50/80; B60L 53/12; B60L 58/13; B60L 53/62; B60L 53/66

(52) U.S. Cl. CPC H01F 38/14; H02J 7/02; H02J 50/40; H02J 50/10; H02J 7/0048; B60L 53/66; H02J 50/80; B60L 53/12; B60L 58/13; B60L 53/62; H02J 7/00032

(57) ABSTRACT

A vehicle charging system is provided that allows a plurality of vehicles to be charged simultaneously while driving along a road. The system includes a series of primary coils that are mounted within a road surface and a secondary coil that is mounted within at least one vehicle. Each primary coil in the series of primary coils includes at least two loops having opposite polarities. In addition, the secondary coil includes at least two loops having opposite polarities. The secondary coil then receives a charge from the series of primary coils.

### TECHNICAL FIELD

The present disclosure relates generally to a coil configuration for wireless charging, and more particularly, to a coil having loops of opposite polarity for wireless charging of a vehicle.

### BACKGROUND

Electric vehicles and hybrid electric vehicles are types of environmentally-friendly vehicles that utilize an electric motor for generating driving power and a battery that stores power to then be supplied to the electric motor. The battery is charged with power that is supplied from an external power supply. Various techniques have been developed in relation to the charging of the vehicle batteries to provide more efficient driving.

Vehicle batteries are capable of being charged using a household power supply or using an external power source at a charging station typically located at a parking facility or along a road. However, charging using an external power source such as a plug-in power source often requires many hours to receive a full charge, thus further increases the time to reach a destination. Additionally, such charging stations are not commonly found today thus also increasing driver inconvenience and making long distance driving difficult.

Various wireless charging techniques have been researched to reduce the burdens of plug-in charging. However, many developed techniques are limited to static charging in which a vehicle is still required to remain parked for a substantial period of time. In developed charging systems that are not limited static charging, in other words, in systems where a vehicle may be driven while being charged, the coil structures are separated or disposed at a distance from each other thus causing dips in the charge transfer and reducing the charge rate. Some charging coils may be placed near each other on a surface to transfer a charge to a corresponding coil in the vehicle. However, developed configurations are limited. For example, despite the coils being disposed near each other, the coils are still separated from each other and due to such a configuration, dips are often experienced and especially along a curved or inclined road where there is a break between each coil. Thus, there is a need for development of a technique that provides an improved charging consistency along varied road surfaces.

### SUMMARY

The present disclosure provides a vehicle charging system that improves the distance a vehicle is capable of traveling by providing dynamic charging. The system also allows a plurality of vehicles to be charged simultaneously by being installed within a road surface along a route. By allowing a vehicle to be charged while driving along a route, the present disclosure is capable of reducing the amount of time needed for vehicle charging and avoids the need to search for a charging station. In addition, due to the configuration of the coil in the vehicle charging system, the coils within the road surface are capable of also receiving a charge from a vehicle when a vehicle battery is fully charged. For example, some vehicles driving over the coils within the road may receive a charge while others may transmit power back to the coils. The plurality of coils within the road surface are connected to a single power source, thus further simplifying the vehicle charging system.

According to one aspect of the present disclosure, a vehicle charging system may include a series of primary coils mounted within a road surface and a secondary coil mounted within at least one vehicle. Each primary coil in the series of primary coils includes at least two loops having opposite polarities and the secondary coil includes at least two loops having opposite polarities. The secondary coil may receive a charge from the series of primary coils.

According to one exemplary embodiment of the present disclosure, the secondary coil may receive the charge from the series of primary coils as the at least one vehicle drives over the road surface. The series of primary coils is connected to a single power source. The secondary coil and each primary coil in the series of primary coils may each include a first portion, a second portion, and a third portion that is parallel to the first portion. The second portion is disposed between the first portion and the third portion. A first loop is formed between the first portion and the second portion and a second loop is formed between the second portion and the third portion. Additionally, a polarity of the first loop is opposite to a polarity of the second loop. The first loop curves in a single first direction and the second loop curves in a single second direction which is opposite to the single first direction.

Additionally, according to an exemplary embodiment of the present disclosure, the series of primary coils may be configured to receive a charge from the secondary coil when a state of charge of a battery of the vehicle is greater than a predetermined threshold. Adjacent primary coils in the series of primary coils may overlap. The series of primary coils may also be mounted in an inclined road surface. In one exemplary embodiment, the road surface may be a curved road surface having an inside curve and an outside curve. Adjacent loops in the primary coils may overlap along the inside curve of the curved road surface. In another exemplary embodiment, a first loop in each primary coil may be offset by a particular angle from a second loop in each primary coil.

The secondary coil may include a first secondary coil mounted within a first vehicle and a second secondary coil mounted within a second vehicle. The first secondary coil and the second secondary coil may each simultaneously transmit a charge to the series of primary coils. The first secondary coil may receive a charge from the series of primary coils while the second secondary coil transmits a charge to the series of primary coils.

According to another aspect of the present disclosure, a vehicle charging method may include monitoring, by a battery management system (BMS), a state of charge (SOC) of a battery of a vehicle. In response to determining that the SOC of the battery is less than a predetermined threshold, the method may include transmitting a charge request to a roadway power source. The roadway power source is connected to a series of primary coils mounted within a road. Additionally, the method may include receiving a charge sequence at a secondary coil mounted within the vehicle from the series of primary coils to charge the battery of the vehicle. Each primary coil in the series of primary coils includes at least two loops having opposite polarities and the secondary coil includes at least two loops having opposite polarities.

Further, in response to determining that the SOC of the battery is greater than the predetermined threshold, a discharge request signal may be transmitted to the roadway power source. Additionally, the method may then include receiving a discharge request confirmation signal at the BMS from the roadway power source and transmitting a charge from the secondary coil of the vehicle to the series of primary coils. The discharge request signal may be transmitted in response to receiving a user input confirming the transmission of the discharge request signal. The charge sequence from the series of primary coils may be transmitted simultaneously to other vehicles traveling along the road in which the series of primary coils are mounted. Additionally, the series of primary coils is connected to a single power source.

According to another aspect of the present disclosure, a charging coil is provided. The charging coil may include a first portion, a second portion, and a third portion that is parallel to the first portion. The second portion is disposed between the first portion and the third portion. A first loop is formed between the first portion and the second portion and a second loop is formed between the second portion and the third portion. A polarity of the first loop is opposite to a polarity of the second loop. Additionally, the first loop curves in a single first direction and the second loop curves in a single second direction which is opposite to the single first direction.

Notably, the present disclosure is not limited to the combination of the charging elements as listed above and may be assembled in any combination of elements are described herein.

Other aspects of the disclosure as disclosed infra.

### BRIEF DESCRIPTION OF THE DRAWINGS

The exemplary embodiments herein may be better understood by referring to the following description in conjunction with the accompanying drawings in which like reference numerals indicate identically or functionally similar elements, of which:

FIG. 1 illustrates a vehicle charging system according to an exemplary embodiment of the present disclosure;

FIG. 2A illustrates a series of coils along a road having loops of different polarities according to an exemplary embodiment of the present disclosure;

FIG. 2B illustrates a coil design according to the prior art;

FIG. 3A and FIG. 3B illustrate the electromagnetic field generated by the configuration of the present disclosure and that of the prior art;

FIG. 4 illustrates the infinity coil according to an exemplary embodiment of the present disclosure;

FIG. 5A and FIG. 5B illustrate the polarities of the infinity coil of FIG. 4 according to an exemplary embodiment of the present disclosure;

FIG. 6 illustrates the polarity of a series of primary coils according to an exemplary embodiment of the present disclosure;

FIG. 7A and FIG. 7B provide graphs of the average power transfer rate of the configuration of the present disclosure compared to that of the prior art;

FIG. 8A and FIG. 8B illustrate an overlapping coil design and corresponding average power transfer rate of such a configuration according to an exemplary embodiment of the present disclosure;

FIGS. 9A-9C illustrate coil designs according to another exemplary embodiment of the present disclosure; and

FIG. 10 illustrates a flowchart of a vehicle charging method according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present disclosure generally provides a vehicle charging system that is capable of dynamically charging a vehicle. In an exemplary embodiment, the vehicle charging system includes a series of coils that are installed within a road surface and a separate coil that is mounted within a vehicle. The series of coils are advantageously connected to a single power source. The particular design of the coil provides opposite polarity within one coil from a single continuous winding configuration which thus generates an energy vortex that allows both charge and discharge between the series of coils (e.g., the grid) and the vehicle. The particular coil design provides a continuous stream of charge at a consistent rate. In addition, the series of coils are capable of being mounted in any type of road surface shape allowing vehicles to charge while driving over varied road surfaces. The configuration also allows multiple vehicles to charge at the same time without requiring a stop at a charging station. User convenience is thus increased substantially by omitting both the need for a charging station and the long time required for charging at such a station. In addition, by omitting the need to stop at a charging station, the configuration also increases the distance a vehicle may be driven.

A person skilled in the art will appreciate that, while the system is disclosed herein for vehicle charging, the system is capable of being used in a variety of other wireless charging capacities. For example, the coils may be installed within a charging area capable of charging a plurality of stationary components. The coils may be mounted within a chamber in which a plurality of different battery operated devices may be charged statically such as a scooter, a bike, boards, etc. In these examples, the coil may be considered as an omnidirectional coil.

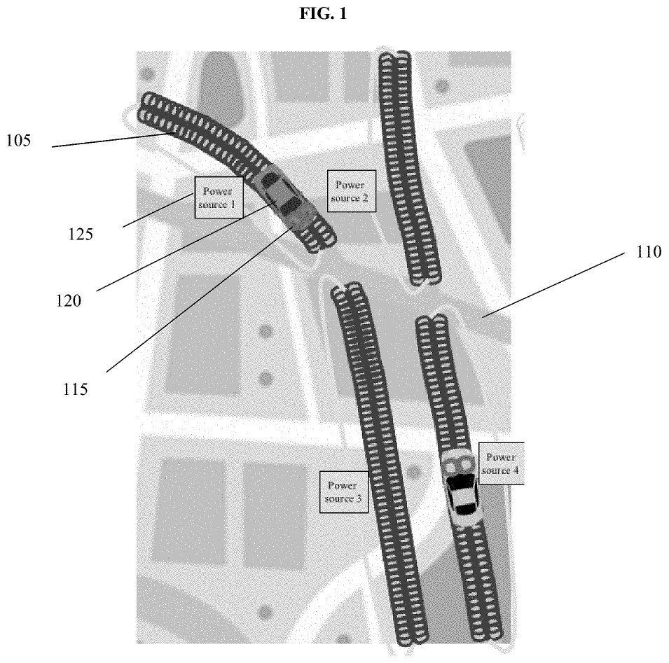

Referring now to the drawings, FIG. 1 illustrates an overview of the vehicle charging system according to an exemplary embodiment of the present disclosure. In particular, FIG. 1 illustrates a series of primary coils 105 mounted within a road 110 on which a vehicle 120 is being driven. As shown, the series of primary coils 105 are connected to a single power source 125. Additionally, a secondary coil 115 is mounted within a vehicle, for example, underneath the vehicle but the present disclosure is not limited to such a location. Accordingly, the series of primary coils 105 receives power from the power source 125 and the energy therefrom is then inductively transferred to the secondary coil 115 as the vehicle 120 drives over the road 110 in which the series of primary coils 105 are installed. Additionally, the secondary coil 115 is also capable of transmitting energy back to the series of primary coils 105. Thus, each section of a series of primary coils is capable of individually receiving or transmitting power simultaneously to multiple vehicles.

As shown, multiple roads may include a similar configuration with a series of primary coils connected to a single power source. By requiring only a single power source for each series of primary coils, the vehicle charging system is capable of providing a more consistent power transfer. Conversely, conventional systems provide discontinuous rates of charge due to the coil design and thus cause power transfer dips between adjacent coils. Additionally, by providing the dynamic charging capability, the present disclosure alleviates the need to find a charging station along a route. Such charging stations require the vehicle to be stopped during long periods of time for charging the vehicle battery. Charging stations are also less common than conventional gas stations and thus may be few in number along particular routes which makes travel over long distances challenging.

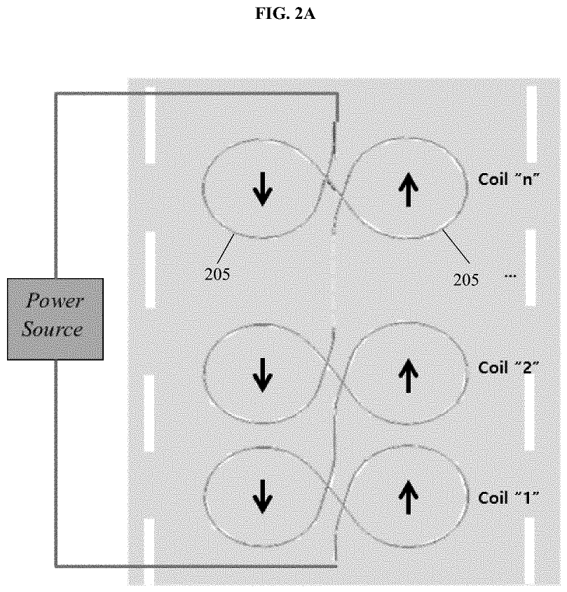

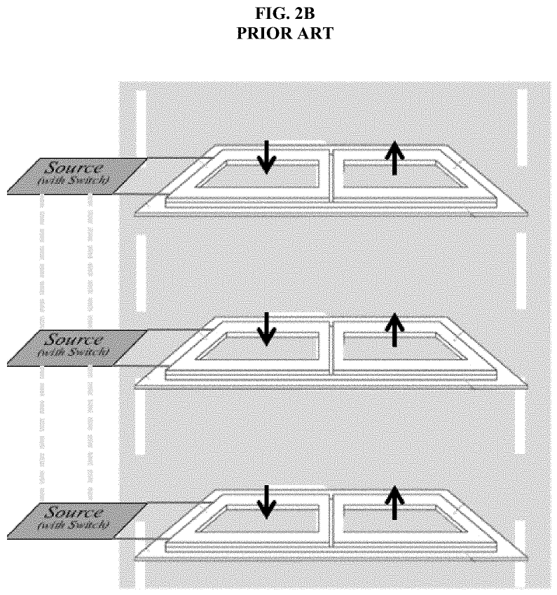

FIGS. 2A and 2B provide a further comparison of the series of primary coils 105 in a road surface according to the present disclosure and conventional systems. In particular, as shown in FIG. 2A, multiple coils may be connected continuously in a winding formation to thus generate the series of primary coils. Each coil in the series includes two loops 205. As indicated by the arrows in FIG. 2A, the two loops have opposite polarity. In other words, the opposite polarities are generated from a single continuous winding configuration. The first coil in a series of primary coils and the last coil in the series of primary coils are connected to the same power source which provides energy to the entire series of primary coils for transmission to the vehicle battery via a secondary coil. Thus as seen in FIG. 2A, the coil configuration continues in a single winding into each adjacent coil such that the coils in the series of primary coils are continuously connected. The conventional coils, as shown in FIG. 2B, are unable to provide a continuous looping configuration between adjacent coils. Accordingly, each loop pair or each coil is required to be connected to a separate power source. Between each coil in FIG. 2B, a power transfer dip may be experienced thus reducing the consistency of charging. Such a configuration thus decreases the overall charging efficiency compared to the coiled configuration of the present disclosure.

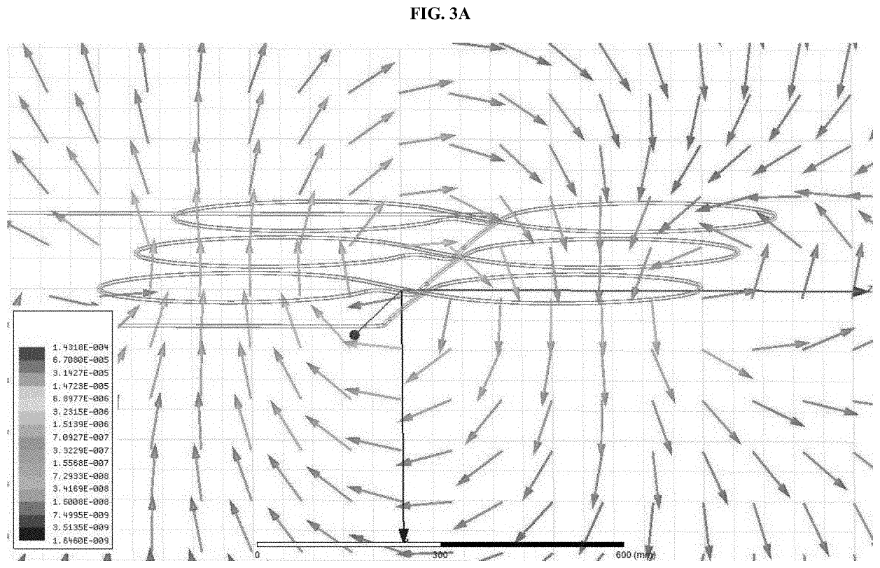

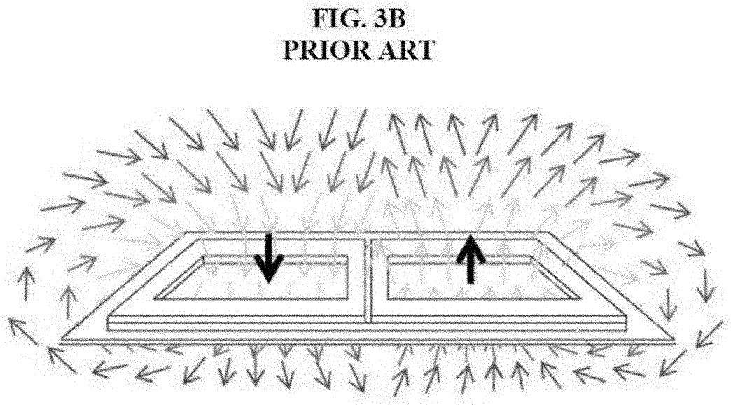

To further illustrate the polarities of the configurations, FIGS. 3A and 3B provide comparison of the electromagnetic fields generated by the configuration in the present disclosure and that of the coil configuration of FIG. 2B. As shown in FIG. 3A, the continuous winding of the coil in the two loops by itself provides the opposite polarity. This structure allows for dynamic charging. In other words, the coil configuration is capable of transmitting power to a vehicle as the vehicle drives along a road. FIG. 3B shows the electromagnetic field generated by the coil configuration shown in FIG. 2B. The electromagnetic field of opposite polarity is generated based on a switching mechanism to thus provide static charging. Such a switching mechanism eliminates the possibility of providing dynamic charging in the conventional systems.

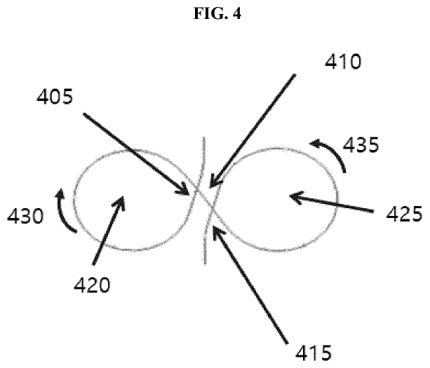

Furthermore, FIG. 4 provides a detailed view of the coil design of the present disclosure. In particular, each coil may include three portions, a first portion 405, a second portion 410, and a third portion 415 with the first portion 405 parallel to the third portion 415. The second portion 410 is disposed between the first portion 405 and the third portion 415. Additionally, the second portion 410 is transverse to the first portion 405 and the third portion 415. Thus, as shown, the coil may start at the first portion 405, loop towards the second portion 410 to loop again and end at the third portion 415. In particular, a first loop 420 is formed between the first portion 405 and the second portion 410 and a second loop 425 is formed between the second portion 410 and the third portion 415. The first loop 420 has a first polarity and the second loop 425 has a second polarity which is specifically opposite to the first polarity of the first loop 420. As further shown in FIG. 4, the first loop 420 curves in a first single direction 430 and the second loop 425 curves in a second single direction 435. The first direction 430 and the second direction 435 are opposite. This configuration may be referred to as an infinity coil due to the continuous loop winding thereof.

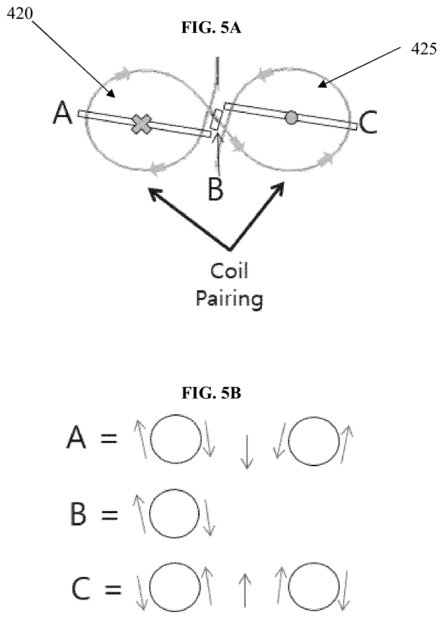

FIG. 5A provides a further illustration of the coil polarity illustrated in FIG. 4. FIG. 5A illustrates the first loop 420 and the second loop 425. Additionally “A” represents the first portion, “B” represents the second portion, and “C” represents the third portion. The “x” represents a downward polarity and the “o” represents an upward polarity, wherein the “x” and “o” are of opposite polarity. Thus, each coil is paired with two loops of opposite polarity. As further illustrated in FIG. 5B, “A” shows a cutaway view of the downward polarity side of the coil in the first loop 420 and “C” shows a cutaway view of the upward polarity side of the coil in the second loop 425. The connection portion of the coil is shown by element “B” which connects the first and second loops.

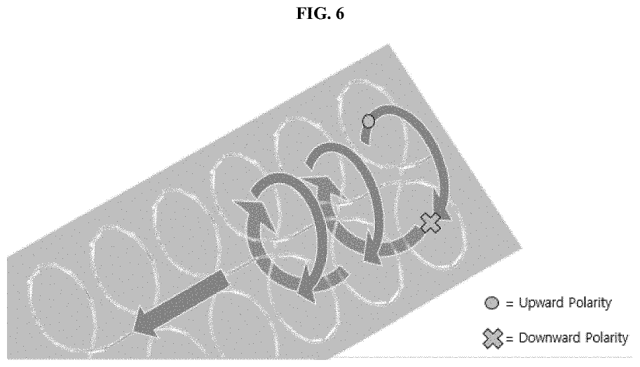

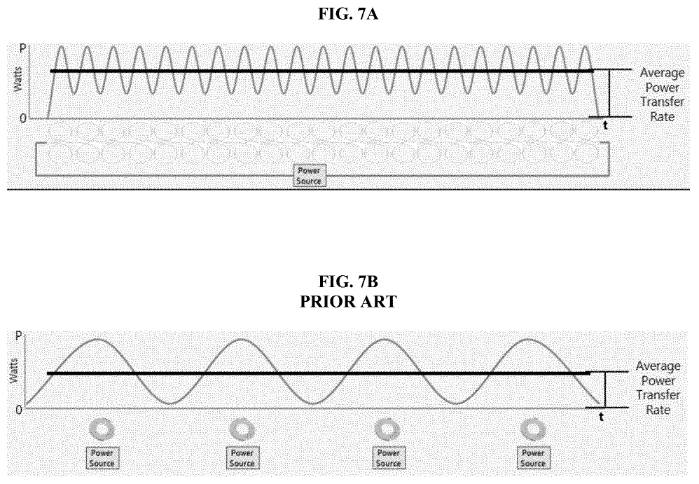

Furthermore, FIG. 6 illustrates a detailed view of a series of primary coils. That is, FIG. 6 illustrates the coil of FIGS. 4-5B in a continuous winding to form the series of primary coils. Due to the looping directions configuration of the coil, the series is capable of being formed as a continuous winding without breaks. This advantageously prevents any dips or breaks in transferring power and provides a consistent rate of charge as the energy is being transferred. In other words, links are not required between each coil due to the continuous winding configuration. FIG. 6 further illustrates the opposite polarities in each pair of loop of each coil in the series of primary coils. This series may be installed within a road surface and be connected to a single power source. Particularly, as shown in FIG. 7A, this infinity coil design exhibits an advantageous power transfer rate due to the consistency thereof. In comparison, FIG. 7B provides a graph of the average power transfer rate of the convention coil design. FIG. 7B shows the lower charge rate resulting from the configuration of a conventional coil design. As discussed above, the conventional coil design consists of separate coils having gaps therebetween and also requiring a power source at each coil, thus causing the lower charge rate compared to the coil design of the present disclosure.

The above-described coil configuration of the present disclosure has been described as being mounted in a road surface. Additionally, the coil design of FIG. 4 may be provided as a secondary coil within the vehicle, particularly, underneath the vehicle. However, the present disclosure is not limited to such a location within the vehicle. Additionally, as discussed, the series of primary coils forms a dynamic charge coil section in which a plurality of vehicles may receive a charge simultaneously. The coil design, however, is not limited to transmitting power to the vehicles. Due to the infinity coil design, vehicles may individually receive or transmit a charge simultaneously as each vehicle drives over the charge coil section on the road in which the primary coils are mounted.

For example, a first secondary coil may be mounted within a first vehicle and a second secondary coil may be mounted within a second vehicle. The first and second secondary coils may each simultaneously transmit a charge to the series of primary coils. Alternately, the first secondary coil (or the second secondary coil) may receive a charge from the series of primary coils while the second secondary coil (or the first secondary coil) transmits a charge to the series of primary coils. As mentioned, the discharge of power from a secondary coil may be based on a state of charge (SOC) of the vehicle battery. For example, if the SOC is less than a predetermined threshold, the secondary coil may opt to receive a charge. Conversely, if the SOC is greater than a predetermined threshold, the secondary coil may opt to transmit power to the series of primary coils (back to the grid).

Accordingly, one vehicle may receive a charge while another vehicle also traveling over the same charge coil section discharges power and transmits a charge to the series of primary coils (e.g., back to the grid). The determination of whether to receive or transmit a charge may be based on the state of charge (SOC) of the vehicle battery as monitored by a battery management system within the vehicle. In the conventional coil design, vehicles on a single coil section are all required to either receive or transmit a charge. In other words, the secondary coils in the vehicles are not capable of operating independently of each other. Thus, due to the limited capability of the conventional systems as well as requiring far more power sources, the conventional systems are considerably less efficient than the coil design of the present disclosure.

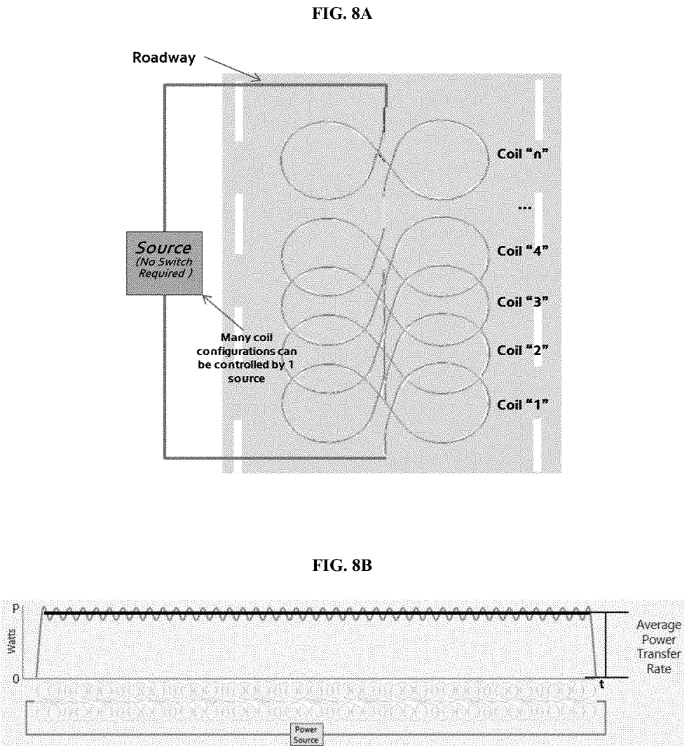

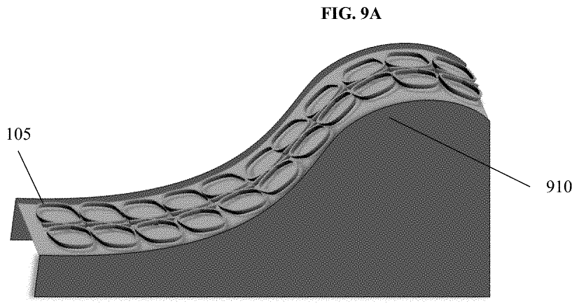

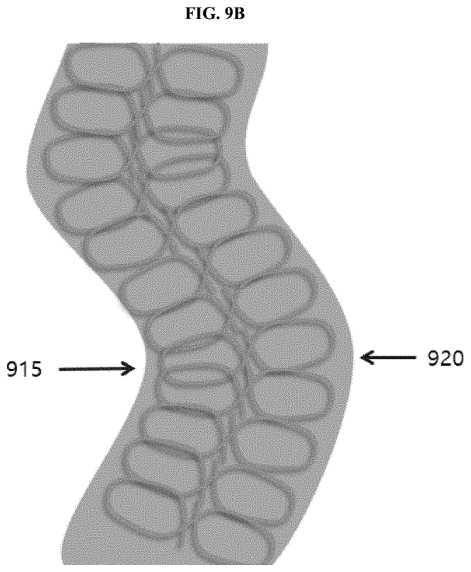

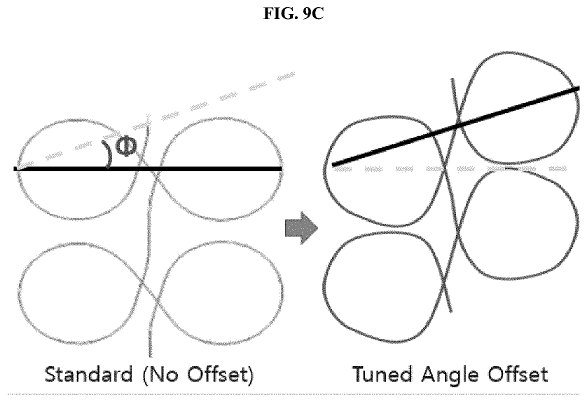

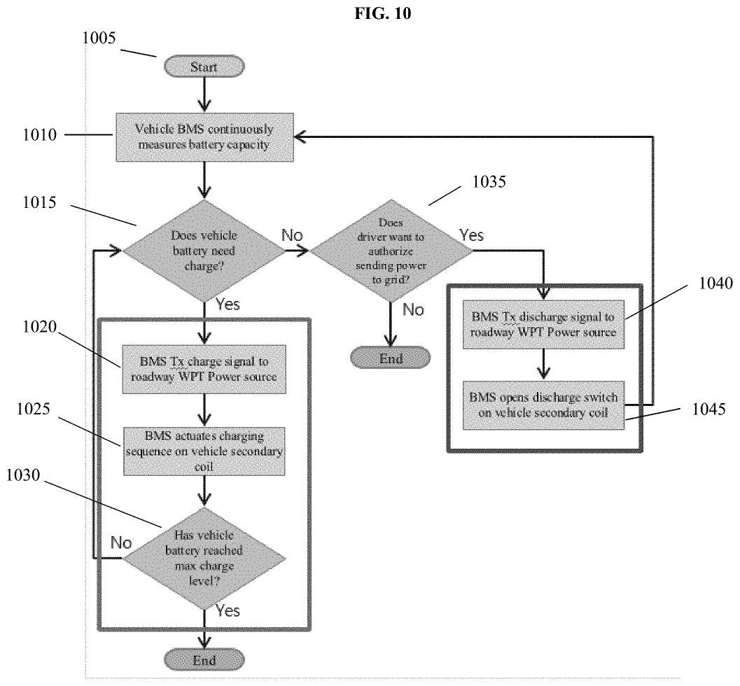

The present disclosure, however, is not limited to the coil configuration as discussed above, and may be varied in different manners. First, FIGS. 8A-8B illustrate an alternate configuration in which adjacent coils in the series of primary coils overlap. In particular, the overlap may of about 50%, but is not limited thereto. By overlapping the coils within a series of primary coils, the average power transfer rate is further increased as shown in FIG. 8B compared to FIG. 7A. Additionally, as shown in FIGS. 9A-9C, the primary coils may be formed in alternate configurations with different coil geometries. For example, FIG. 9A illustrates a series of primary coils mounted within a road surface which is inclined. In other words, the coil design described herein is compatible with different road surfaces including various inclines and the like along a path. Additionally, FIG. 9B illustrates a coil design along a curved road. As shown, in this configuration, some of the adjacent coils may overlap while others remain spaced apart or abutting. In particular, the curved road surface may include an inner curve 915 and an outer curve 920. The loops of the coils at the inner curve 915 may overlap while the loops of the coils at the outer curve 920 remain separated. Thus, due to the continuous winding configuration of the coil design, the coils are capable of being adaptable to different types of road surfaces and shapes.

In addition, as shown in FIG. 9C, the loops of a coil may be offset from each other. That is, in the configuration as discussed above (FIG. 4), the loops of each coil may be in line with each other (e.g., a consistent angle from a center line). In another embodiment, the first loop may be offset from the second loop. In this embodiment, the angle between the electromagnetic field direction 1 may be tuned by changing the dimensional parameters. Such an angle offset may be useful to accommodate different vehicle speeds along a road. For example, the tuned angle offset may also be useful along a highway where vehicles travel at higher speeds.

A description will now be provided of a method for executing vehicle charging using the infinity coil design as described herein. The method may begin at S1005 and proceed to the battery management system (BMS) continuously monitoring a SOC of the battery of the vehicle (S1010). Based on a such a monitoring, the BMS may determine whether the vehicle battery requires a charge (S1015). Such a determination may be based on a variety of different factors. For example, the charge determination may be based on whether the SOC is less than a predetermined threshold or may be determined on a remaining distance to a destination in comparison to the current state of charge of the battery.

In response to determining that the vehicle battery does not need a charge (e.g., the SOC is greater than the predetermined threshold), the vehicle may opt to transmit power back to the grid or back to the series of primary coils. In particular, in response to determining that the SOC of the battery is greater than the predetermined threshold, a discharge request signal may be transmitted by the BMS to a roadway power source (S1040). The BMS may then open a discharge switch on a the secondary coil (S1045) in response to receiving a discharge request confirmation signal from the roadway power source. In one embodiment, the transmission of the discharge from the secondary coil may be conditional upon a driver authorization of the power transmission (S1035). For example, the discharge request signal may be transmitted in response to receiving a user input confirming that transmission of the discharge request signal (S1035).

Further, at S1015, in response to determining that the vehicle battery requires a charge (e.g., the SOC is less than the predetermined threshold), the BMS may transmit a charge request signal to a roadway power source (S1020). Notably, the roadway power source may be connected to the series of primary coils mounted within the road. The BMS may then receive a charge sequence at the secondary coil mounted within the vehicle from the series of primary coils to thus charge the battery of the vehicle (S1025). The secondary coil may continue to receive the charge from the series of primary coils until the SOC of the battery has reached a maximum charge level (S1030). Additionally, the charge sequence from the series of primary coils may be transmitted simultaneously to other vehicles traveling along the road in which the series of primary coils are mounted.

Moreover, the vehicle charging system described herein may be implemented in a variety of different manners. For example, the series of primary coils may be mounted within any road surface or alternately, may be mounted in a designated lane. Similar to a high-occupancy lane, roads may include a designated charging lane on which vehicle may travel when requiring a charge. Such a lane designation may prevent overcrowding on a charging lane. In other words, vehicles may pull out into a non-charging lane once fully charged, thus leaving the designated lane for vehicles requiring a charge.

In another embodiment, the charging system may be integrated with a service fee or subscription. For example, vehicles traveling on a charging roadway may be automatically charged a fee for receiving the charge. Similarly, the vehicles may receive a credit when transferring power back to the power source of the coil section on the road. The present disclosure is also not limited to passenger vehicles and may be applied to any type of device traveling along a roadway. The vehicle charging may also be provided as a subscription service for a fleet of vehicles. For example, a user may subscribe to using a vehicle in a vehicle fleet and such a subscription may include driving in a charging designated lane along a roadway.

Accordingly, as described above, the present disclosure provides an improved wireless charging system in which a vehicle may be dynamically charged while being driven over a roadway in which a continuously infinity coil section is installed. A plurality of vehicles may be charged simultaneously while driving over such an infinity coil section having loops of opposite polarity in the road and the vehicles may each also transfer power back to the roadway power source to thus maintain an advantageous state of charge of a vehicle battery. The charging system described herein omits the need for a user to spend hours at a charging station and thus improves efficiency of long distance travel. Additionally, by merely requiring a single power source for a series of primary coils in a roadway, the present disclosure is capable of preventing dips in power transfer and instead provides continuously rate of charge to a vehicle.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A vehicle charging system, comprising:
a series of primary coils mounted within a road surface; and
a secondary coil mounted within at least one vehicle,
wherein each primary coil in the series of primary coils includes at least two loops having opposite polarities,
wherein the secondary coil includes at least two loops having opposite polarities, and
wherein the secondary coil receives a charge from the series of primary coils.

2. The vehicle charging system of claim 1, wherein the secondary coil receives the charge from the series of primary coils as the at least one vehicle drives over the road surface.

3. The vehicle charging system of claim 2, wherein the series of primary coils is connected to a single power source.

4. The vehicle charging system of claim 1, wherein the secondary coil and each primary coil in the series of primary coils each include:
a first portion;
a second portion; and
a third portion parallel to the first portion, wherein the second portion is disposed between the first portion and the third portion,
wherein a first loop is formed between the first portion and the second portion,
wherein a second loop is formed between the second portion and the third portion, and
wherein a polarity of the first loop is opposite to a polarity of the second loop.

5. The vehicle charging system of claim 4, wherein the first loop curves in a single first direction and the second loop curves in a single second direction which is opposite to the single first direction.

6. The vehicle charging system of claim 1, wherein the series of primary coils is configured to receive a charge from the secondary coil when a state of charge of a battery of the vehicle is greater than a predetermined threshold.

7. The vehicle charging system of claim 1, wherein adjacent primary coils in the series of primary coils overlap.

8. The vehicle charging system of claim 1, wherein the series of primary coils are mounted in an inclined road surface.

9. The vehicle charging system of claim 1, wherein the road surface is a curved road surface having an inside curve and an outside curve, and wherein adjacent loops in the primary coils overlap along the inside curve of the curved road surface.

10. The vehicle charging system of claim 1, wherein a first loop in each primary coil is offset by a particular angle from a second loop in each primary coil.

11. The vehicle charging system of claim 1, wherein the secondary coil includes:
a first secondary coil mounted within a first vehicle; and
a second secondary coil mounted within a second vehicle.

12. The vehicle charging system of claim 11, wherein the first secondary coil and the second secondary coil each simultaneously transmit a charge to the series of primary coils.

13. The vehicle charging system of claim 11, wherein the first secondary coil receives a charge from the series of primary coils while the second secondary coil transmits a charge to the series of primary coils.

14. A vehicle charging method, comprising:
monitoring, by a battery management system (BMS), a state of charge (SOC) of a battery of a vehicle;
in response to determining that the SOC of the battery is less than a predetermined threshold, transmitting a charge request to a roadway power source, wherein the roadway power source is connected to a series of primary coils mounted within a road;
receiving a charge sequence at a secondary coil mounted within the vehicle from the series of primary coils to charge the battery of the vehicle,
wherein each primary coil in the series of primary coils includes at least two loops having opposite polarities, and
wherein the secondary coil includes at least two loops having opposite polarities.

15. The vehicle charging system of claim 14, further comprising:
in response to determining that the SOC of the battery is greater than the predetermined threshold, transmitting a discharge request signal to the roadway power source;
receiving a discharge request confirmation signal at the BMS from the roadway power source; and
transmitting a charge from the secondary coil of the vehicle to the series of primary coils.

16. The vehicle charging system of claim 15, wherein the discharge request signal is transmitted in response to receiving a user input confirming the transmission of the discharge request signal.

17. The vehicle charging system of claim 14, wherein the charge sequence from the series of primary coils is simultaneously transmitted to other vehicles traveling along the road in which the series of primary coils are mounted.

18. The vehicle charging system of claim 14, wherein the series of primary coils is connected to a single power source.

19. A charging coil, comprising:
a first portion;
a second portion; and
a third portion parallel to the first portion, wherein the second portion is disposed between the first portion and the third portion,
wherein a first loop is formed between the first portion and the second portion,
wherein a second loop is formed between the second portion and the third portion, and
wherein a polarity of the first loop is opposite to a polarity of the second loop.

20. The charging coil of claim 19, wherein the first loop curves in a single first direction and the second loop curves in a single second direction which is opposite to the single first direction.
